(19) United States
(12) Patent Application Publication
(10) Pub. No.: US 2014/0117045 A1
(43) Pub. Date: May 1, 2014

(54) MIXING NOZZLE ASSEMBLY HAVING A VALVE ELEMENT, FLUID DISPENSING ASSEMBLY, AND RELATED METHOD

(71) Applicant: NORDSON CORPORATION, Westlake, OH (US)

(72) Inventor: Leslie J. Varga, Duluth, GA (US)

(73) Assignee: NORDSON CORPORATION, Westlake, OH (US)

(21) Appl. No.: 13/798,203

(22) Filed: Mar. 13, 2013

Related U.S. Application Data
(60) Provisional application No. 61/719,046, filed on Oct. 26, 2012.

(51) Int. Cl. B67D 7/78

(52) U.S. Cl. CPC B01F 5/008
USPC 222/145.5

(57) ABSTRACT

A mixing nozzle assembly for mixing and dispensing fluids includes a nozzle body having an inlet for receiving fluids and an outlet for dispensing fluids. A mixing element is positioned in the nozzle body and is configured for mixing the fluids. A valve member extends through the mixing element. The valve member is configured to selectively open and close the outlet.

### CROSS-REFERENCE TO RELATED APPLICATION

This application claims the priority of application Ser. No. 61/719,046 filed Oct. 26, 2012 (pending), the disclosure of which is hereby incorporated by reference herein.

### FIELD OF THE INVENTION

The present invention generally relates to dispensing equipment, and more particularly to mixing nozzle assemblies used in fluid dispensing assemblies for dispensing fluids.

### BACKGROUND

Nozzles are used in the dispensing arts for dispensing fluids. For example, many adhesive dispensers include a nozzle that is coupled with an adhesive source, and fluid adhesive is moved from the adhesive source and through the nozzle as part of a dispensing procedure. So-called mixing nozzles are known and include features for mixing a plurality of fluids into a composite fluid as the fluids flow through the nozzle. In a known arrangement, a nozzle includes a mixing element having a plurality of baffles around which fluid flows as it makes its way through the nozzle.

Dispensing procedures sometimes require dispensing of fluid to be started and stopped. However, the tendency of nozzles to leak fluid even after dispensing has stopped is a problem. In addition to wasting fluid material, fluid leaks can cause fluid to be dispensed at times and at locations where it is not intended. This is undesirable, as it presents an impediment to more thorough control of fluid dispensing procedures.

There is a need, therefore, for mixing nozzle assemblies that address one or more of the shortcomings discussed above.

### SUMMARY OF THE INVENTION

Embodiments of the present invention are directed to mixing nozzle assemblies that include a valve member for controlling the flow of fluid. Other embodiments of the invention are related to fluid dispensing assemblies having mixing nozzle assemblies as described herein, and methods of dispensing fluid from mixing nozzle assemblies.

According to one embodiment of the invention, a mixing nozzle assembly for mixing and dispensing fluids includes a nozzle body having an inlet for receiving fluids and an outlet for dispensing fluids, a mixing element positioned in the nozzle body and configured for mixing fluids, and a valve member extending through the mixing element, the valve member being configured to selectively open and close the outlet. The valve member may be configured to move in any suitable manner for the purpose of allowing and preventing fluid flow through the outlet. Two options, for example, are linear and rotational movement.

According to another embodiment of the invention, a fluid dispensing assembly for dispensing fluids includes a manifold configured to receive fluids from a plurality of fluid sources, and a mixing nozzle assembly coupled with the manifold configured to receive fluids therefrom, to mix fluids and to control dispensing of fluids. The mixing nozzle assembly includes a nozzle body having an interior and an outlet, a mixing element received in the interior of the nozzle body, and a valve member extending through the mixing element movable to selectively allow and prevent fluid flow through the outlet.

According to yet another embodiment of the invention, a method of dispensing fluids from a mixing nozzle assembly is provided. The mixing nozzle assemble includes a nozzle body including an inlet and an outlet, a mixing element positioned in the nozzle body, and a valve member extending through the mixing element and moveable to selectively allow and prevent flow of fluids through the outlet. The method includes moving the valve member relative to the mixing element to allow fluid flow through the outlet, directing the fluids into the nozzle body through the inlet and along the mixing element, mixing the fluids, and dispensing the fluids from the outlet of the nozzle body.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a cross-sectional view depicting a fluid dispensing assembly constructed according to the concepts of the present invention.

FIG. 1A is an enlarged view of the nozzle body dispensing tip shown in FIG. 1, with a valve member moved out of sealing engagement with a valve seat.

FIG. 2 is a cross-sectional view depicting an alternative fluid dispensing assembly.

FIG. 3 is a partially disassembled isometric view depicting an alternative construction of a mixing element.

FIG. 4 is a sectional view taken substantially along line 4-4 of FIG. 3.

FIG. 5 is a sectional view taken substantially along line 5-5 of FIG. 3.

FIG. 6 is an enlarged cross-view depicting an alternative nozzle body dispensing tip.

### DETAILED DESCRIPTION OF THE ILLUSTRATIVE EMBODIMENTS

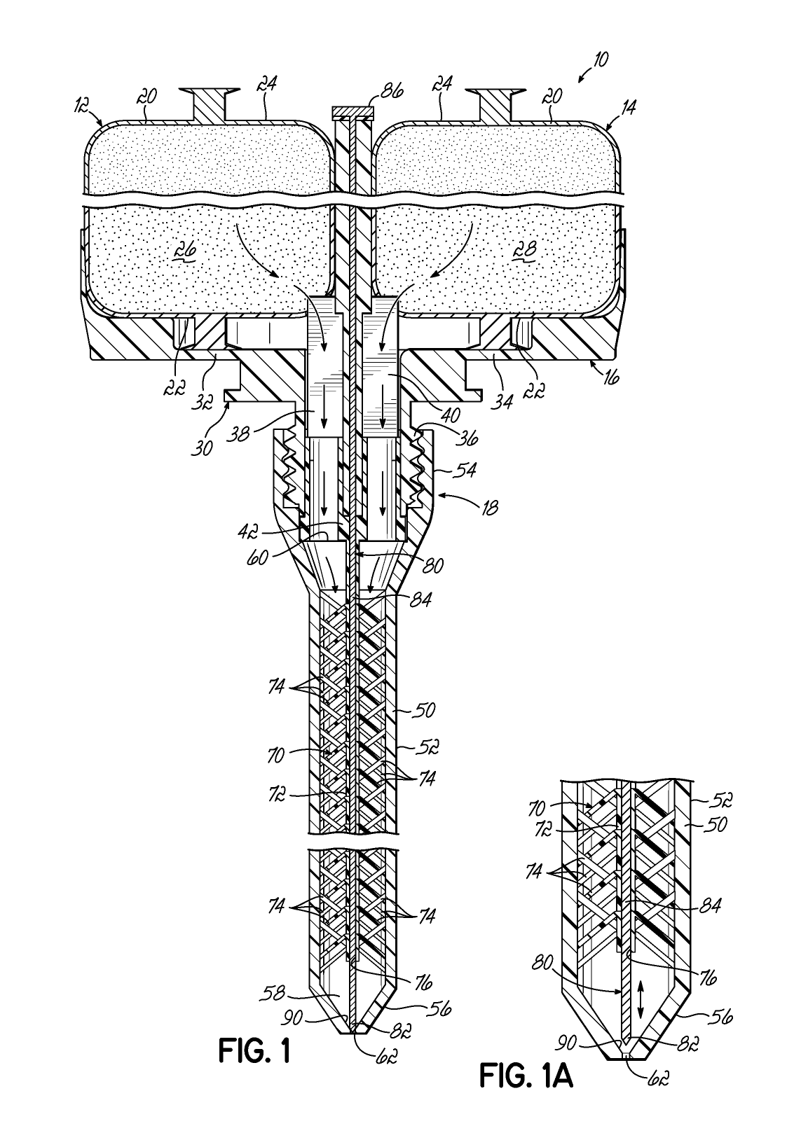

Referring to the figures, and beginning with FIGS. 1 and 1A, an exemplary fluid dispensing assembly 10 is shown. The fluid dispensing assembly 10 generally includes first and second fluid containers 12, 14, a manifold 16, and a mixing nozzle assembly 18. The mixing nozzle assembly 18 provides control of fluid dispensing from the fluid dispensing assembly 10, as will be described.

In the embodiment shown, the fluid containers 12, 14 each include a flexible and collapsible, yet resilient, membrane 20. Thus, the containers 12, 14 are of the type sometimes referred to as collapsible containers. The membrane 20 is configured to be pierced in order provide access to the material contained within the membrane 20. The containers 12, 14 are generally cylindrical in shape and each extends between a first end 22 and a second end 24, with the membrane 20 being crimped closed at each end 22, 24, as shown. The first container 12 contains a first fluid 26 and the second container 14 contains a second fluid 28 (FIG. 1). The first and second fluids 26, 28 may be similar or different, and are typically different so that a mixture of the two forms a composite fluid. While containers 12, 14 shown and described herein are collapsible containers, it will be appreciated that the present invention is also applicable to other types of containers, including for example, syringe-type containers that are not considered collapsible.

The containers 12, 14 are coupled with the manifold 16. More particularly, the manifold 16 includes a body 30 having a first receptacle 32, a second receptacle 34, and a neck 36. The first and second receptacles 32, 34 are configured to receive, or be coupled with, the first and second containers 12, 14, respectively. As shown, the first end 22 of each container 12, 14 is received within the first and second receptacles 32, 34. The neck 36 is configured to receive the mixing nozzle assembly 18.

The body 30 of the manifold 16 also provides a first passageway 38 communicating with the first receptacle 32 and the neck 36, and a second passageway 40 communicating with the second receptacle 34 and the neck 36. The first and second passageways 38, 40 are configured to allow fluid flow between the receptacles 32, 34 and the neck 36. In particular, the first fluid 26 in the first container 12 is able to flow into the first passageway 38 of the manifold 16 and move from the area of the first receptacle 32 (as it leaves the first container 12) and to the neck 36. Likewise, the second fluid 28 in the second container 14 is able to flow into the second passageway 40 of the manifold 16 and move from the area of the second receptacle 34 (as it leaves the second container 14) and to the neck 36. The body 30 of the manifold 16 includes a partition 42 for maintaining the first and second passageways 38, 40 separate from one another, so as to avoid mixing of the first and second fluids 26, 28 while they are in the manifold 16.

The mixing nozzle assembly 18 includes a nozzle body 50 having a main shaft portion 52, a flared base 54, and a tapered dispensing tip 56. A cavity or interior 58 is defined within the body 50. An inlet 60 is defined in the base 54, and an outlet 62 is defined in the dispensing tip 56. The nozzle body 50 is configured to receive fluid, such as the first and second fluids 26, 28 from the first and second containers 12, 14. The nozzle body 50 is also configured to attach with the manifold 16. In particular, the base 54 of the nozzle body 50 threadingly engages with the neck 36 of the manifold 16, as shown. When the nozzle body 50 is attached with the manifold 16, the inlet 60 of the nozzle body 50 communicates with the first and second passageways 38, 40 in the manifold 16 for receiving fluid contents therefrom.

The mixing nozzle assembly 18 also includes a mixing element 70 that is positioned in the interior 58 of the nozzle body 50. The mixing element 70 is configured to mix fluids as they pass through the nozzle body 50. As shown, the mixing element 70 is generally positioned in the shaft portion 52 of the nozzle body 50 between the base 54 and the dispensing tip 56. The mixing element 70 generally includes a hub portion 72 and a plurality of baffles 74 extending from the hub portion 72. As fluid passes through the nozzle body 50, it moves around the baffles 74 and the hub portion 72, causing it to mix. For example, when the first and second fluids 26, 28 are introduced into the inlet 60 of the nozzle body 50 from the manifold 16, the fluids are generally separate. As the fluids 26, 28 move through the nozzle body 50 toward the dispensing tip 56, the fluids pass along the mixing element 70 and move around the baffles 74 and the hub portion 72, thereby mixing to form a composite fluid.

The mixing element 70 also defines a through bore 76 extending through the hub portion 72 which is configured to receive a valve member that is configured to control the flow of fluid through the outlet 62 of the nozzle body 50.

In particular, the mixing nozzle assembly 18 also includes a valve member 80 that is configured to extend through the mixing element 70 and selectively control the flow of fluid through the outlet 62 of the nozzle body 50. The valve member 80 includes a valve tip 82 and a shaft 84. An actuator 86 is coupled with the shaft 84 and is used to move the valve member 80. In the example provided, the valve member 80 moves in a linear manner, however, other forms of movement such as rotational movement may be used instead, depending on the design and configuration of the desired valve. The valve tip 82 is configured to engage with a valve seat 90 formed proximate the outlet 62 of the nozzle body 50. In the embodiment shown, the valve seat 90 is formed on the interior of the nozzle body 50 in the dispensing tip 56 near the outlet 62. The shaft 84 extends from the valve tip 82 and extends through the bore 76 of the mixing element 70. The shaft 84 further extends beyond the nozzle body 50 and through a portion of the manifold 16 and connects with the actuator 86. The actuator 86 is used to move the valve member 80 into and out of engagement with the valve seat 90. In the embodiment shown, the actuator 86 is a flange that attaches with the shaft 84, but it will be appreciated that other actuators can also be connected with the valve member 80, such as a pneumatic or electric actuator. In addition, the actuator 86 is provided in a useful position relative to the features of the fluid dispensing assembly 10 so that it can be accessed by a user and used to move the valve member 80. In the embodiment shown, the actuator 86 is positioned generally at the rearward end of the fluid dispensing assembly 10 and between the first and second containers 12, 14.

The valve member 80 is slidably moveable with respect to the nozzle body 50 and the mixing element 70, as indicated by the double-headed arrow in FIG. 1A. For example, the valve member 80 is slidably moveable between a first position (as shown in FIG. 1) where the valve tip 82 is in sealing engagement with the valve seat 90, and a second position (as shown in FIG. 1A) where the valve tip 82 is not in sealing engagement with the valve seat 90. When the valve tip 82 is in sealing engagement with the valve seat 90, the outlet 62 is sealed closed, and fluid cannot be dispensed from the nozzle body 50 through the outlet 62. Conversely, when the valve tip 82 is not in sealing engagement with the valve seat 90, the outlet 62 is open and fluid can be dispensed from the nozzle body 50 through the outlet 62. A user can grasp the actuator 86 to move the valve member 80 between these respective first and second positions.

Operation of the fluid dispensing assembly 10 is now described. When a user desires to dispense fluid from the outlet 62, and if the outlet 62 is closed, the user grasps the actuator 86 and moves it so the valve tip 82 is not in sealing engagement with the valve seat 90. In particular, the actuator 86 is used to move the valve element 80 relative to the nozzle body 50 and the mixing element 70 so as to open the outlet 62. Fluid can then be directed through the nozzle body 50 and out the outlet 62. In particular, the first and second fluids 26, 28 can be directed from the first and second containers 12, 14 and through the manifold 16 and into the nozzle body 50. The fluids 26, 28 can be further directed through the nozzle body 50 and along the mixing element 70 as the fluids pass from the inlet 60 to the outlet 62. The fluids 26, 28 mix as they move around the hub portion 72 and the baffles 74 of the mixing element 70, so that as the fluids reach the outlet 62 they have been somewhat, if not completely, mixed. When a user is finished dispensing fluid from the outlet 62, the user grasps the actuator and moves it so the valve tip 82 comes into sealing engagement with the valve seat 90. In particular, the actuator 86 is used to move the valve 80 relative to the nozzle body 50 and the mixing element so as to close the outlet 62. Closing the outlet 62 prevents unintended dispensing or leaking of fluid from the fluid dispensing assembly 10.

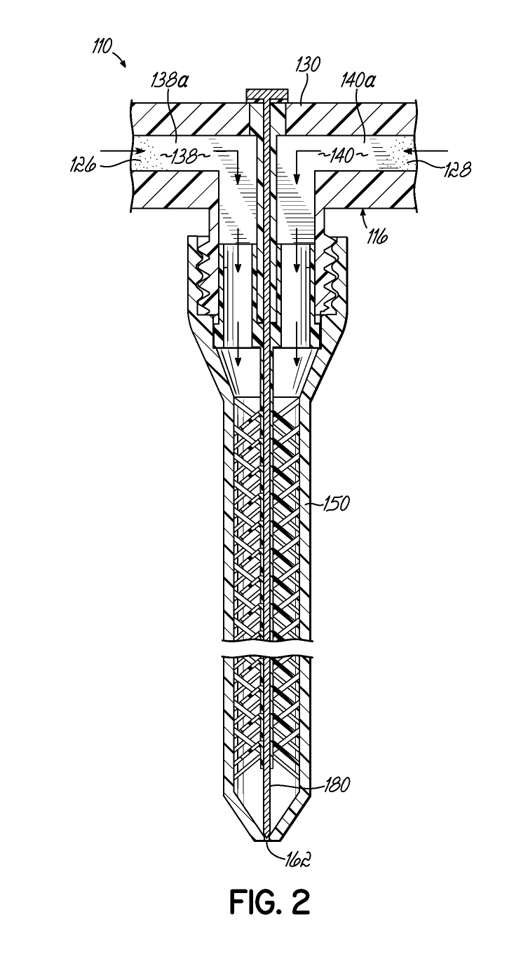

Referring next to FIG. 2, an alternative fluid dispensing assembly 110 is shown. The fluid dispensing assembly 110 shares many features in common with the fluid dispensing assembly 10, but has a slightly different manifold 116. In particular, the manifold 116 includes a body 130 that is configured to connect with a source of fluids in a different manner than what is shown in FIG. 1. The body 130 generally defines a first passageway 138 that communicates with a source (not shown) of a first fluid 126, and a second passageway 140 that communicates with a source (not shown) of a second fluid 128. The first and second passageways 138, 140 include portions 138a, 140a that are generally perpendicular to a major length axis of the nozzle body 150. A valve member 180 operates in a similar manner as the valve member 80 described above for opening and closing an outlet 162 in the nozzle body 150.

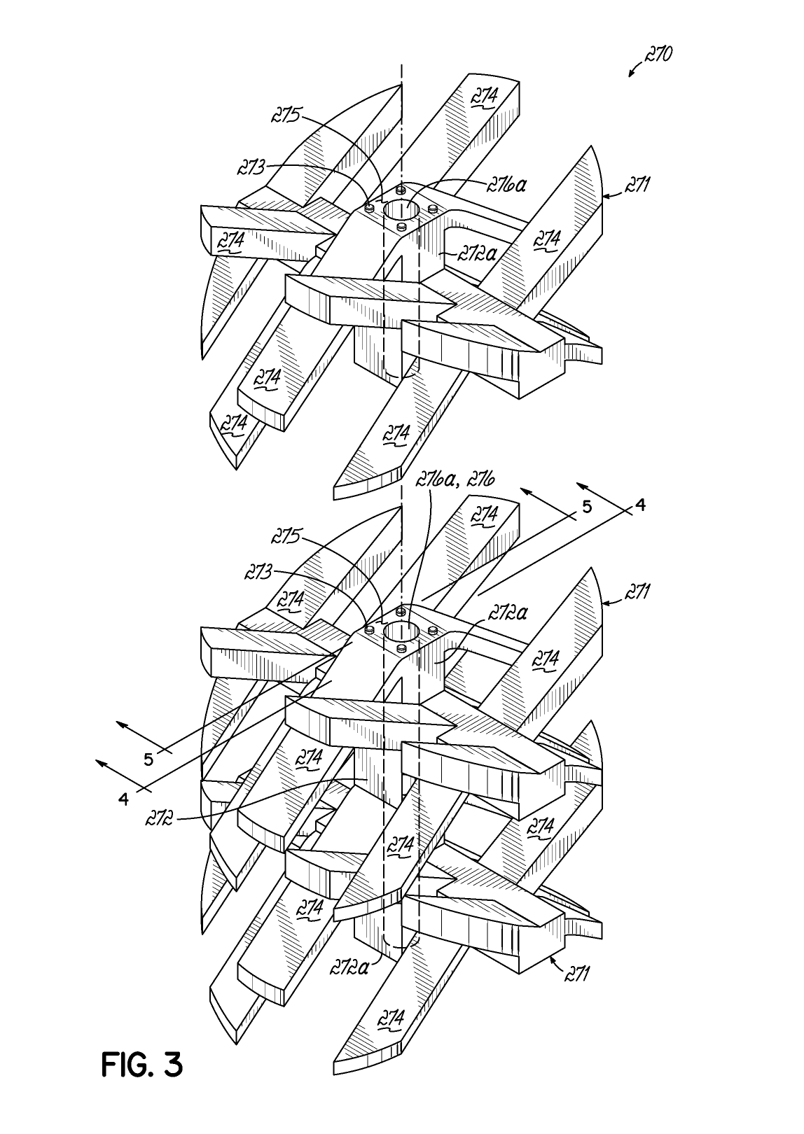

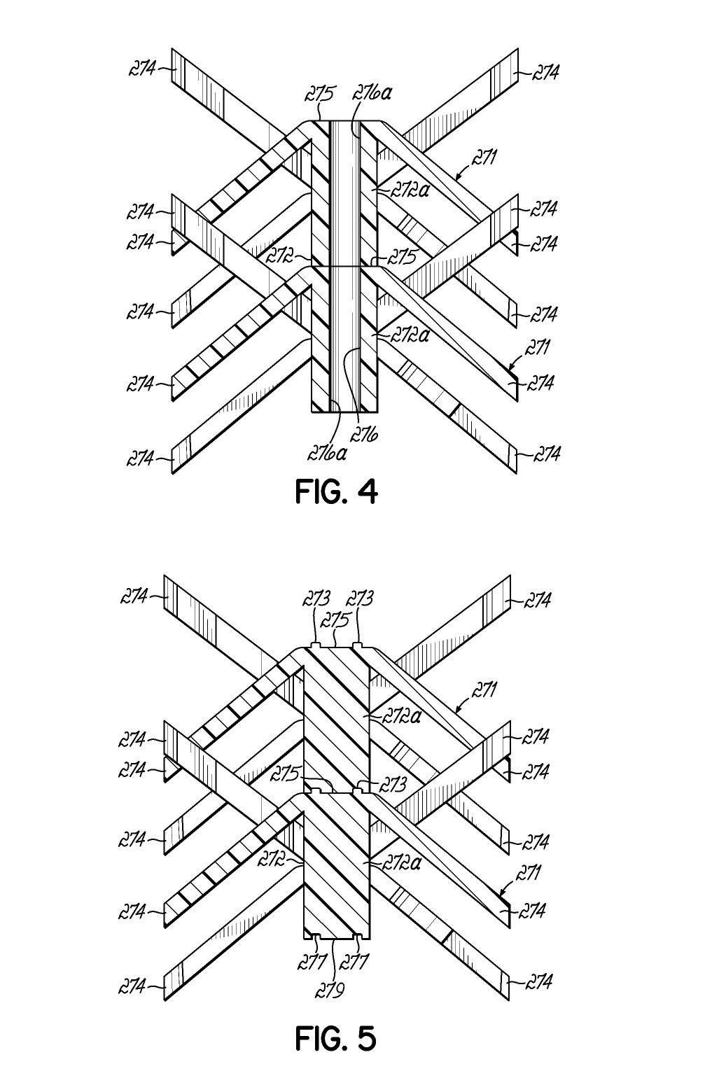

Referring next to FIGS. 3-5, an alternative construction of a mixing element 270 is shown. The mixing element 270 shares many features in common with the mixing element 70, but is comprised of several discrete mixing element segments 271. Each mixing element segment 271 includes a hub portion 272a so as to provide a hub portion 272 when assembled with the other mixing element segments 271 to form the complete mixing element 270 (as shown in FIGS. 3-5). Each mixing element segment 271 also includes a plurality of baffles 274 extending from the hub portion 272a so as to provide the plurality of baffles 274 when assembled with the other mixing element segments 271 to form the complete mixing element 270 (as shown in FIGS. 3-5). Further, each mixing element 271 also includes a bore 276a so as to provide a bore 276 of the complete mixing element 270 (as shown in FIGS. 3 and 4). A mixing element can be constructed having any number of mixing element segments 271, such as depending on the desired length of the mixing element.

In the embodiment shown, the mixing element segments 271 are connected with one another in an interlocking arrangement. In particular, a plurality of projections 273 extend from an upper surface 275 of each hub portion 272a and are received in correspondingly shaped sockets 277 formed in a lower surface 279 of an adjacent hub portion 272a (as shown in FIGS. 3 and 5). The mixing elements 271 could alternatively be connected or assembled together in any appropriate manner. For example, the mixing element segments 271 may be simply stacked one upon the next to form the mixing element 270.

A mixing element, such as mixing element 270, may be used in conjunction with a mixing nozzle assembly and provides a bore configured to receive a valve member, as discussed above. For example, the mixing element 270 can be used in place of the mixing element 70 discussed above in the fluid dispensing assembly 10.

While the mixing elements 271 shown in the figures are substantially similar, the mixing elements 271 could also be provided with differently shaped baffles, so that a mixing element 270 could be comprised of several mixing elements 271 have different baffle configurations.

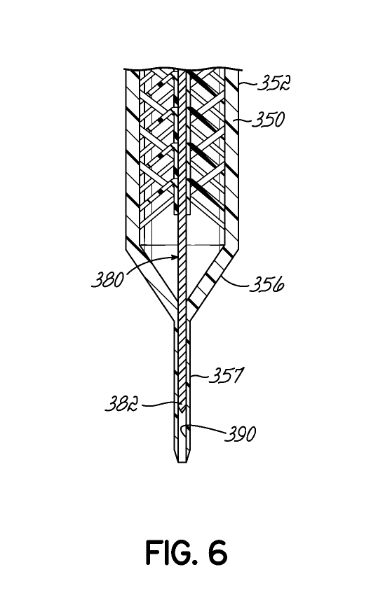

Referring next to FIG. 6, a portion of an alternative nozzle body 350 is shown. The nozzle body 350 includes a shaft portion 352 that tapers to a dispensing tip 356, which itself includes an elongate tip shaft 357. The elongate tip shaft 357 defines a valve seat 390 for a valve member 380. In particular, a valve tip 382 is received in the elongate tip shaft 357 when the valve member 380 is moved so as to provide a sealing engagement between the valve tip 382 and the valve seat 390. Conversely, the valve tip 382 is removable from the elongate tip shaft 357 when the valve member 380 is moved so as to not have a sealing engagement between the valve tip 382 and the valve seat 390.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept. What is claimed is:

1. A mixing nozzle assembly for mixing and dispensing fluids, comprising:
a nozzle body having an inlet for receiving fluids and an outlet for dispensing fluids,
a mixing element positioned in the nozzle body for mixing the fluids, and
a valve member extending through the mixing element, the valve member being configured to selectively open and close the outlet.

2. The mixing nozzle assembly of claim 1, the mixing element being comprised of a plurality of mixing element segments.

3. The mixing nozzle assembly of claim 2, the mixing element segments being connected by interlocking engagement between adjacent mixing element segments.

4. The mixing nozzle assembly of claim 1, the mixing element including a plurality of mixing baffles.

5. The mixing nozzle assembly of claim 4, the mixing element further including a hub portion including a through bore, the mixing baffles extending from the hub portion and the valve member extending through the through bore.

6. The mixing nozzle assembly of claim 1, the nozzle body having a valve seat adjacent the outlet, the valve member being configured to selectively engage the valve seat.

7. The mixing nozzle assembly of claim 6, the nozzle body having a tapered dispensing tip, the outlet being formed in the tapered dispensing tip, wherein the valve seat is formed on an interior of the dispensing tip.

8. A fluid dispensing assembly for dispensing fluids, comprising:
a manifold configured to receive fluids from a plurality of fluid sources, and
a mixing nozzle assembly coupled with the manifold configured to receive fluids therefrom, to mix fluids and to control dispensing of fluids, the mixing nozzle assembly including
a nozzle body having an interior communicating with an outlet,
a mixing element received in the interior of the nozzle body for mixing the fluids, and
a valve member extending through the mixing element and movable to selectively allow and prevent fluid flow through the outlet.

9. The fluid dispensing assembly of claim 8, the mixing element of the mixing nozzle assembly being comprised of a plurality of mixing element segments.

10. The fluid dispensing assembly of claim 9, the mixing element segments being connected by interlocking engagement between adjacent mixing element segments.

11. The fluid dispensing assembly of claim 8, the mixing element further including a hub portion and a plurality of mixing baffles extending from the hub portion, the hub portion including a through bore and the valve member extending through the through bore.

12. The fluid dispensing assembly of claim 8, the nozzle body having a tapered dispensing tip, the outlet being formed in the tapered dispensing tip, the valve seat being formed on an interior of the dispensing tip.

13. The fluid dispensing assembly of claim 8, the nozzle body having a valve seat adjacent the outlet, the valve member being configured to selectively engage the valve seat.

14. The fluid dispensing assembly of claim 8, further comprising an actuator coupled with the valve member for moving the valve member.

15. A method of dispensing fluids from a mixing nozzle assembly including a nozzle body including an inlet and an outlet, a mixing element positioned in the nozzle body, and a valve member extending through the mixing element and moveable to selectively allow and prevent flow of fluids through the outlet, the method comprising:
moving the valve member relative to the mixing element to allow fluid flow through the outlet,
directing the fluids into the nozzle body through the inlet and along the mixing element,
mixing the fluids with the mixing element, and
dispensing the fluids from the outlet of the nozzle body.

16. The method of claim 15, wherein moving the valve member includes moving the valve member out of engagement with a valve seat.

17. The method of claim 15, wherein moving the valve member includes using an actuator to move the valve member.

18. The method of claim 15, wherein the mixing element defines a through bore and wherein
moving the valve member includes moving the valve member in the through bore.

19. The method of claim 15, further comprising moving the valve member relative to the mixing element to prevent fluid flow through the outlet.
